(19) United States
(12) Patent Application Publication
(10) Pub. No.: US 2010/0128072 A1
(43) Pub. Date: May 27, 2010

(54) UNIVERSALLY USABLE ELECTRONIC MANUAL STAMPING DEVICE

(76) Inventor: Andreas Wagner, Berlin (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/512,068

(22) Filed: Jul. 30, 2009

(30) Foreign Application Priority Data
Nov. 26, 2008 (DE) 10 2008 059 009.6

(51) Int. Cl. B41J 29/38

(52) U.S. Cl. 347/5

(57) ABSTRACT

A universally usable electronic manual stamping device has an inkjet print head that can be moved back and forth in a print window, the print window being arranged in a base plate facing toward a print medium during the printing. A control unit of the device is connected with a user interface, with an external interface and with an internal interface. The inkjet print head is operationally connected via the internal interface with an actuator to move the inkjet print head and with an internal power source to supply the control unit, the inkjet print head and its actuator, as well as the interfaces. The control unit includes a security processor that possesses at least one transaction module which is provided to implement cryptographic security and certification tasks in connection with the printing of an individually secured stamp imprint. The control unit is programmed to control the printing and a base station onto which the manual stamping device is fashioned to be placed for its maintenance and downloading with data.

### BACKGROUND OF THE INVENTION

1. Field of the Invention

The invention concerns a universally usable electronic manual stamping device, suitable for generation of incoming mail stamp imprints, sequential numbering imprints and fee stamp imprints as well as franking imprints with security features and certificates. As used herein, “universally usable electronic manual stamping devices” means a portable end user device that cannot only print but also bill and store monetary data, and that can also generate and store other security-relevant data or can print certificates. In particular, at least one additional application can be made available for a digital manual printer as a small, mobile manual franking machine with a digital printer.

2. Description of the Prior Art

An electronic manual franker is known from European Patents EP 755028 B1, EP 750277 B1, which can be moved manually without limits over a print medium. Unique imprints or certificates cannot be generated with this known device.

A method for operating a franking and addressing machine according to European Patent EP 944 028 B1 processes signals of the relative movement between the print head and a letter as well as control of the information processes in order to generate a security imprint at the same time as implementing specific print head movement processes. The letter is supplied standing on edge in the transport direction and is not moved during the printing. The print head can be moved in x/y directions during the printing.

A method and device to generate a print image in multiple steps is known from European Patent EP 1 244 063 B1, in which a transverse offset between the print head and the print medium is generated between the printing of two partial images, while the print medium remains stationary.

In contrast to this, at least one print head is moved in a line and the print medium is moved orthogonal thereto in conventional printers operated at a PC, and in electronic typewriters.

In conventional franking machines, for example in the Ultimail® (commercially available from Francotyp Postalia GmbH), only the print medium is moved (EP 1 170 141 B1).

For PC franking, for example in stampit by DPAG and in the franking machines (Mymail®, Ultimail®) from Francotyp Postalia GmbH, portable, stationary devices are operated. By contrast, due to their low weight, manual frankers are better suited for mobile use than stationary devices, which exhibit a higher weight and therefore are relatively difficult to carry.

A label printer with control, input and display means that allows a selection of different labels and image features is known from European Patent EP 816 106 B1. A stationary thermoprint head and a label directed past this are provided.

Label printers are known that are able to print to two-dimensional barcodes. However, the print quality of the known digital manual printers is not sufficient for use to print a franking imprint with a two-dimensional barcode.

A printing mechanism for a portable printer in order to move an inkjet print head over a print medium within a frame during printing is known from European Patent EP 1 000 758 B1. A transport device for the print medium (for example paper) is not used for such a printer capable of direct printing, which is manually placed on the print medium before printing. An inclination sensor is required so that the printing is not started while the nozzle surface with the nozzles of the inkjet print head of the portable printer are still located at an angle relative to the surface of the print medium to be printed. The printer can be placed on a base station and be electrically connected with a computer via a USB cable of the base station in order to load an image pattern to be printed from the computer into the printer.

An alternative design of a portable printer is already known from European Patent EP 564 297 B1. Here the portable printer is directly connected with a computer via a USB cable.

Different print tasks exists for applications for which a very low number of prints per day are required, for incoming mail (inbox) stamper, entrance ticket printer, tag or label printers and others. The economic and commercial market factors should be taken into account in the design, meaning that such a printer should be sold in large quantities at correspondingly advantageous prices. Such a printer should be optimally simple to manufacturer and universally usable. A transport device for the print medium can advantageously be done away with.

An incoming mail stamper with a digital print of the JetStamp 790 type is known from the company Reiner (DE 20 2004 011 038 U1). Such a stamper can be connected to a PC in order to download arbitrary data into the stamper, which is known from the German Design Patent DE 20 209 997 U1 (among other things). However, the stamping device of the type “jet stamp 790” from the company Ernst Reiner GmbH delivers a print image with relatively low quality that is not sufficient for a machine-readable, two-dimensional barcode as it is required for a franking imprint. Also, no physical security area is present in the “jet stamp 790” stamping device, and the controller cannot process cryptographic data in order to generate unique stamp imprints.

### SUMMARY OF THE INVENTION

An object of the present invention is to provide a manual stamping device that has a simple design and is universally usable and that can be used in a mobile manner. The hand stamping device should have security features and be fashioned to execute application-specific security-critical transactions and to generate individual, secure stamping imprints that can be inspected for their validity by suitable reading devices.

As used herein, “universal usability” encompasses a wider range of use than just use at a wired location and autarchic or offline use. No data connection with a personal computer (PC) or server is necessary during the generation of an individual, secure stamp imprint.

A fixed sequence of operations, which is considered as a logical unit, is understood as a transaction. For example, in franking a security-critical transaction includes the operations: billing, generation of a security code, and generation of a security imprint.

A security processor has at least one transaction module that enables the device protection. The latter ensues in a known manner by means of a cryptographic checksum of selected or all usable data. The checksum is printed in the form of a security code or, respectively, security feature (for example 2-D barcode) together with clear text data as a security imprint on the surface of the print medium. The transaction module is realized by means of hardware and/or software. Additional transaction modules are realized differently to implement the respective application programs.

The invention is based on the housing of the manual stamping device being executed in multiple parts and having a secure region as access protection for the electronics as well as a non-secure region for storing and contacting the power source (batteries or cells), the actuator device to move the print head and the print carriage of the inkjet print head. Protection of the control lines of the inkjet print head against manipulation for forgery or counterfeiting is unnecessary. Because the inkjet print head generates and prints out a security imprint, for example a certificate or a franking imprint with individual security feature, its validity and uniqueness can be verified by means of a reader.

The universally usable electronic manual stamping device has an inkjet print head that can move back and forth in a printing window with ½ an inch of print width. The print window has an area in which the print head is moved over the print medium. The print window is bounded by a frame. The print head is electronically controlled by a controller in order to move the print head and to eject ink droplets during the movement. A specific print pattern thus can be generated at a high quality. The print window is arranged in a base plate that faces toward a print medium during the printing. Spacers between the print medium and the base plate that prevent a sliding of the print window on the surface of the print medium to be printed are attached on the base plate. The controller is connected with a user interface, via an external interface and an internal interface, and is configured to implement cryptographic security and certification tasks in connection with the printing of an individually secured stamp imprint. Via the internal interface, the controller is connected in terms of operation with the inkjet print head and with an actuator to move the inkjet print head. An internal power source is arranged in the physically insecure region within the housing and serves to supply the controller, the inkjet print head and its actuator as well as the interfaces with power independent of the mains network. The controller is arranged inside the housing in the physically secure region and enables security-critical transactions. It can advantageously comprise a single security process realized as a security semiconductor module in order to execute the following tasks:
control,
implementation of security-critical tasks,
data preparation for printing,
activation and polling the user interface,
communication via external interface(s),
communication via internal interface(s),
control of the inkjet print head,
control of the actuator,
polling the print triggering means (switch, start button).

The controller thus is formed by a security processor that is electrically connected with input and output means, a non-volatile memory, a row of individual display elements, a driver for the actuator, and an electronic print head activation unit, as well as with switching means and with at least one interface. After printing, the universally usable electronic manual stamping device is placed on a correspondingly fashioned, separate service station for power charging and for servicing the inkjet printing technology, and can be operationally connected with a personal computer in order to download or exchange data.

The following selectable modes can be cited under the goal of universal usability of the electronic manual stamping device:
use as an incoming mail stamper,
use as a sequential number printer,
use as a sequential data printer or
use as a fee stamper.

Moreover, the following modes which can be selected as needed, are suitable for fixed-on-site and autarchic implementation of security-critical transactions, including the generation of individually secured stamp imprints:
use as a certificate printer, or
use as a manual franker.

Additional uses of the universally usable electronic manual stamping device with a security processor are:
the connection to a location given the execution of security-critical transactions, including the generation of individually secured stamp imprints,
the autarchic “offline” operating mode given the execution of security-critical transactions including the generation of individually secured stamp imprints, thus without the necessity of a wireless or wired data connection to a PC or server during the stamping,
the protection of the confidential data and key necessary to implement the security-critical transaction, including the generation of individually secured stamp imprints,
the protected execution of application-specific security-critical functions.

### BRIEF DESCRIPTION OF THE DRAWINGS

FIG. 1 is a block diagram of the controller of a universally usable electronic manual stamping device in accordance with the invention.

FIG. 2a is a front view of the universally usable electronic manual stamping device in accordance with the invention.

FIG. 2b is a side view of the universally usable electronic manual stamping device, from the right in accordance with the invention.

FIG. 3 is a perspective view of a PC and view of the universally usable electronic manual stamping device in accordance with the invention. from the front, standing in a maintenance position on a base station.

FIG. 4 is an embodiment of a flowchart for operation of the universally usable electronic manual stamping device in accordance with the invention in a franking mode.

### DESCRIPTION OF THE PREFERRED EMBODIMENTS

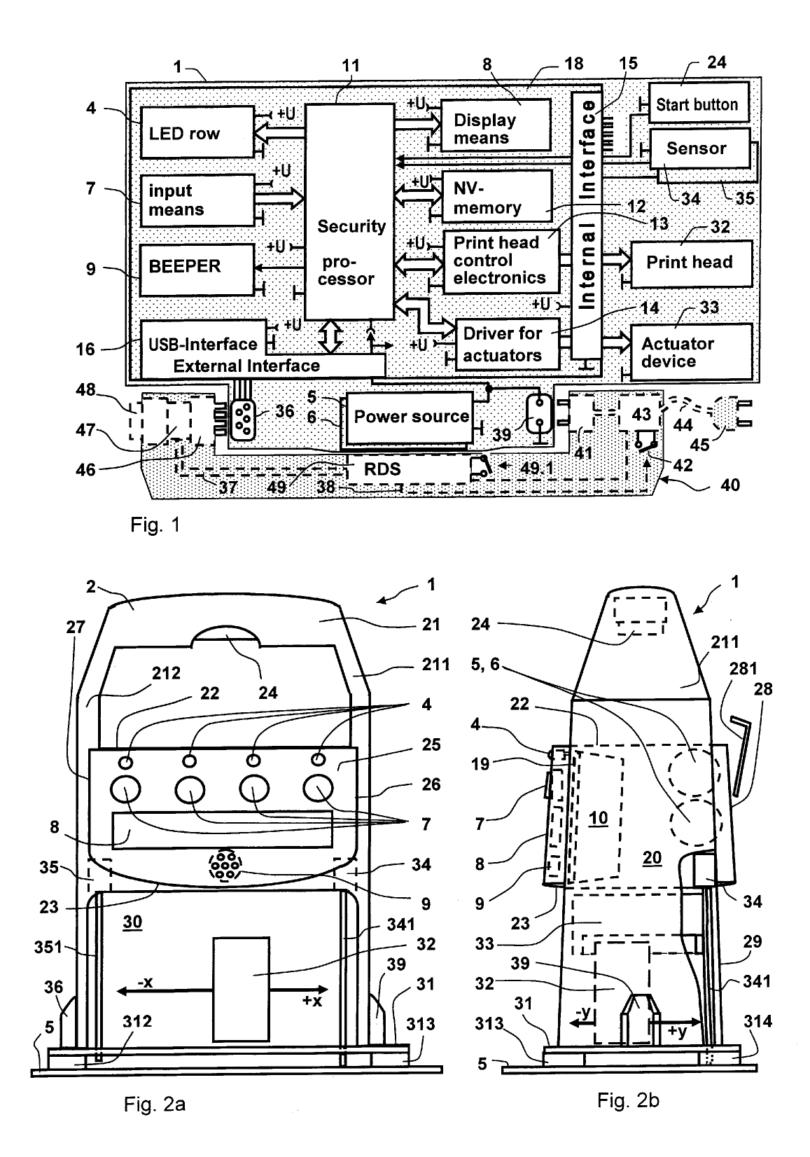

A block diagram of an embodiment the controller of a universally usable electronic manual stamping device 1 with modules 4, 7, 8, 9, 12, 13, 14 and 15 of the control unit 18, and with external modules 5, 6, 24, 32, 33, 34, 36 as well a 37 through 49 which are operationally connected with the control unit 18, is shown in FIG. 1.

The control unit 18 has an LED display line 4, input unit 7, display unit 8, acoustic signaling unit 9, a non-volatile memory 12, an electronic print head control unit 13, driver 14 for the actuator 33, an internal interface 15 for at least one sensor, the driver and the print head controller and an external interface 16 which are connected with a security processor 11. The input unit 7 has at least one actuation means and, together with the display unit 8, the LED display line 4 and the acoustic signal unit 9 (beeper), forms a user interface that serve(s) for status signaling, data input and selection of the operating mode. At least a portion of the electronics of the control unit 18 is realized in a single integrated circuit. The at least one transaction module is a component of the aforementioned integrated circuit.

The external modules include at least one power source (such as batteries or cells 5, 6), at least one inkjet print head 32, at least one actuator 33 to move a print carriage of the inkjet print head, at least portions of a sensor 34 and 35, a switch 24 and a contact or socket 36 connected with the external interface, as well as an optional contact or socket 39 to recharge the power source in the event that cells 5, 6 are used. The contact or socket 39 for recharging the power source is omitted in the event that batteries are used. The switch 24 is fashioned with a start button. The latter and the sensors 34, 35 are connected via the internal interface 15 with the security processor 11. The at least one print head 32 is connected via the internal interface 15 with the electronic activation unit 13, and the actuator 3 is connected via the internal interface 15 with the driver 14 for actuation. The switch 24 serves as a transaction trigger to initiate security-critical transactions, including the generation of individually secured stamp imprints.

The external modules 37, 38, 41, 42, 43, 44, 45, 46, 47, 48,49 and 49.1 (shown in dashed lines) include components of a base station 40 in which the universally usable electronic manual stamping device 1 is serviced. A cleaning and sealing station 49 (RDS) is installed in the base station for the purpose of maintenance. The base station is connected via a control line 37 with a first branch of a USB connector 47 to whose second branch a commercially-available USB socket 48 is connected. The contact point 46 is fashioned as a plug in order to establish the connection to the socket 36. A switch 49.1 is connected to the cleaning and sealing station 49, which switch 49.1 is open as long as the manual stamping device is not in contact with the base station. A plug 41 is provided at the socket 39, which plug 41 is connected with a mains adapter and charging unit 43 which enables a recharging of the cells 5, 6 as soon as the manual stamping device is in contact with the base station. The mains adapter and charging unit 43 is connected via mains cable 44 with a mains plug 45.

The external modules 37, 38, 41, 42, 43, 44 and 45 drawn in dashed lines can be omitted in the event that exclusively batteries are used as a power source.

FIG. 2a shows a (simplified) front view of the universally usable electronic manual stamping device 1 which stands by means of four feet on the surface to be printed of a print medium 5. Two feet 312 and 313 of the manual stamping device are arranged near the front side and two feed (311 and 314; not visible) are arranged near the back side, below a base plate as a spacer relative to the print medium. The sockets 36 and 39 can be arranged near the feet 312 and 313 or near the feet of the back side on the base plate 31. The base plate 31 possesses a print window opening (not shown) for the inkjet print head 32.

A housing with a handle 2 is arranged on the base plate 31. The handle 2 has a start button 24 that is operated by the operator of the manual stamping device 1 in order to trigger a printing. The start button 24 is centrally integrated on the underside of the handle into a middle part 21 of the handle 2.

The manual stamping device offers a possibility to correct the position of the stamp image only immediately before the placement of the manual stamping device on a print medium. The sensors 34, 35 are arranged inside the housing of the manual stamping device, and therefore are drawn with dashed lines since these are not visible from the outside. The first sensor 34 is fashioned as a microswitch and signals the control unit 18 when the manual stamping device is placed on a print medium. A tactile transfer part 341 reaches from the microswitch to the surface of the print medium 5 and transfers a triggering force to the microswitch. The control unit 18 prevents an accidental triggering by means of the start button 24 before the positioning and placement of the manual stamping device on a print medium. The signal of the sensor 34 starts a time period for calculations by means of the control unit 18 before the triggering of the printing. One advantage of the sensor 34 is that, given an accidental triggering of the start button 24 before the printing, a printing is impossible. Thus no ink is sprayed into the room as long as the manual stamping device has not yet been placed on the print medium.

In contrast to the known stamping with a manual stamping device, in franking the franking stamp should not be printed just anywhere, but rather in a position defined by the postal carrier on the surface of the print medium (mail piece). Such a manual positioning is perhaps not achieved on the first try and must possibly be corrected at least once. The triggering of the start button 24 signals the end of the positioning and orders the beginning of the printing.

As can be seen from the workflow diagram for franking (FIG. 4), a status signaling (acoustically via beeper 9 or, respectively, optically via LED display line 4 or display means 8) should ensue when the manual stamping device has not yet been placed on the print medium or on the base station, i.e. as long as the first sensor 34 is not yet activated.

The manual stamping device thus needs to be aligned or, respectively, positioned in its position above the print medium before a franking/printing. Ink is only sprayed from the inkjet print head when both the switch 24 and sensor 34 have been activated. A time period which might be sufficient for positioning and possibly for imprint calculation and generation of a print image elapses from the point in time of the lifting up to the point in time of triggering by means of the start button 24.

The data processing is started by the first sensor. The required time is possibly insufficient for necessary cryptographic calculations before the initiation of a franking. A time period after the triggering of both switches (the sensor 34 and the start button 24) can also be provided for a delayed start of the print command execution. The latter time period is reduced if multiple stamping imprints are executed in succession. The sensor is also activated at the point in time of raising the manual stamping device from the table or, respectively, upon raising it from the last printed print medium. A cryptographic advance calculation of a security code is already started before the replacement on the following mail piece.

The sensors 34, 35 can be fashioned as microswitches or photoelectric barriers and be arranged (not shown) on the base plate 31 of the manual stamping device or in its internal housing.

In an alternative use of a photoelectric barrier as an optical sensor 34′, transmission part 341′ (advantageously an optical wave guide) is used for light transmission.

In an alternative arrangement of the tactile sensor 34* (microbutton) in the base plate 31, a tactile transfer pin 341 can be omitted.

In an alternative arrangement of the optical sensor 34″ in the base plate 31, a optical transfer part 341′ can be omitted.

An LED display line 4, input means 7, display means 8, acoustic signal means 9 are arranged as operating and signaling means on the front side 25 of the housing between the handle 2 in the upper part of said housing and the foot region in the lower part of said housing, as well as between the right housing side wall 26 and the left housing side wall 27. The handle 2 consists of a middle part 21 and transitions on both sides (via possible side parts 211, 212 slating upwardly) partially into the housing. The side parts 211, 212 are extended downward up to the base plate 31 and fashioned in the shape of posts. By posts what is understood is a lateral grip bar or a molded gripping part. The housing is molded between the parts of the side pieces 211, 212 fashioned as posts and possesses a housing top side 22, a housing bottom 23 and the housing side walls 26 and 27.

The height of a printer space 30 open to the front is defined as a distance between the housing bottom 23 and the base plate 31 of the manual stamping device 1. The width of which printer space 30 is defined by a lateral distance between the housing side walls 26 and 27 and its depth by a distance up to a rear housing wall. At least one inkjet print head 32 with at least one actuation device (not shown) is arranged in the printer space 30 to move a print carriage (not shown) of the inkjet print head over the print medium 5 at least in one x-direction or counter to this. The second sensor 35 can be constructed just like the first sensor 34 and communicates a placement of the device to the base station.

The tactile transfer pin 341 of the first sensor 34, which communicates a placement of the device on the print medium 5, is fashioned longer than a tactile transfer pin 351 of the second sensor 35.

A side view of the universally usable electronic manual stamping device 1 from the right is shown in FIG. 2b. Some parts of the housing, the start button 24 in the handle 2, the actuator device 33 installed in the printer chamber for at least one inkjet print head 32, and the electronic modules 4, 5, 6, 7, 8 and 9 are drawn with dashed lines because these are not visible from the outside.

The non-visible parts of the top side 22 of the housing and housing underside 23 and the non-visible parts of the housing that bound an internal space are drawn with dashed lines. A secure region 10 is thereby differentiated from an insecure region 20. A motherboard 19 with the electronic modules 4, 7, 8 and 9 on the forward-facing side and with security-critical electronic modules (including the transaction module) on the rearward-facing side of the motherboard 19 is arranged in the secure region 10, which motherboard 19 can conduct the control of the universally usable electronic manual stamping device 1 and in particular the calculation of a security code on demand.

The batteries or cells 5, 6 are arranged in the insecure region 20 under a cover 281 that can be exchanged, which cover 281 covers an opening (not visible) in the rear wall 28 of the housing in a closed state.

The part of the side piece 211 (used for a lateral support) is extended from the housing downward to the base plate 31. It has been drawn cut out near a rear wall 29 in order to indicate the internal tactile sensor 34 and the position of the tactile transfer pin 35 extending from the sensor 34 to the print medium 5 via base plate 31. The rear wall 29 is arranged between the parts of the side pieces (used for a lateral support) and transitions upwards into a step in the rear wall 28 of the housing in which the electronic and security-critical electronic modules are arranged. The rear wall 29 transitions downwardly into the base plate 31, or rests thereon.

The base plate 31 is spaced from the print medium 5 by the feet 313 and 314 arranged on the right side.

The socket 39 is molded at the floor into the post-shaped part of the side piece 211 and projects through an opening (not visible) of the base plate 31 so that its contact points are directed in the direction of the print medium 5 or alternatively onto the base station.

In principle, in FIG. 2b the optional possibility is also shown that the at least one inkjet print head 32 can be moved with the same actuator 33 or by means of another actuator to move a print carriage of the inkjet print head in a second y-direction or counter to this, which y-direction lies transversal to the first x-direction or counter to this.

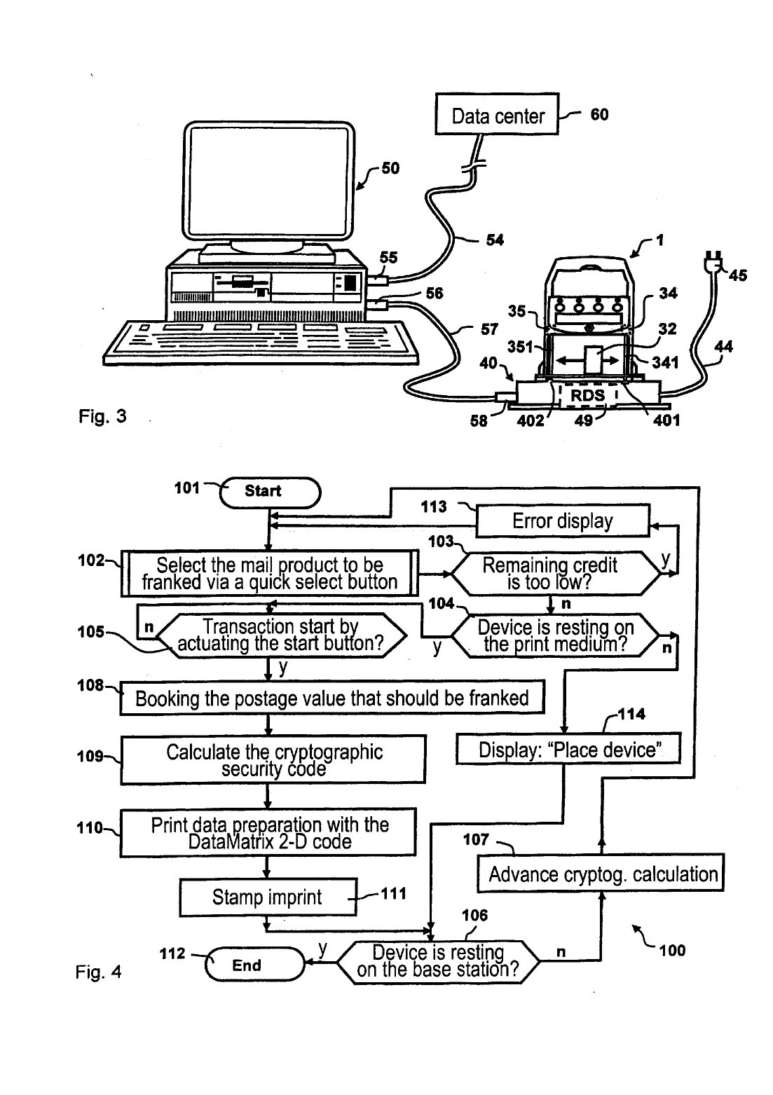

A perspective view of a PC 50 and a view of the universally usable electronic manual stamping device 1 from the front, in a service position standing on a base station 40, is shown in FIG. 3. A commercially available personal computer 50 (PC) possesses a modem, a communication bushing and a USB socket in a known manner. An associated plug connector 56 is plugged into the latter, which plug connector 56 is arranged at the one end of the commercially available USB cable 57.

A plug connector 58 at the other end of the USB cable 57 is plugged into a commercially available USB bushing of the base station 40 with which the manual stamping device 1 was brought into mechanical and electrical contact. A plug 55 of a communication cable 54 is plugged into the communication bushing of the PC to connect with a remote data center 60 via a telephone network (not shown) in order to download monetary data into the manual stamping device 1 via PC 50 and base station 40. The monetary data are stored in the secure region of the manual stamping device in a non-volatile memory, for example as credit.

Alternatively, a device for wireless communication can also be used to connect with the remote data center 60.

A cleaning and sealing station 49 (RDS) was installed in the base station in order to service the at least one inkjet print head 32 as soon as the manual stamping device 1 is placed on the base station.

An internal power source (for example a cell) of the manual stamping device 1 can be recharged if necessary because the base station 40 has a mains adapter and charging unit 43 which can be connected with a power supply grid via mains cable 44 and plug 45.

The sensor signals are continuously monitored by the security processor. If the sensor signal of the first sensor 34 changes from high to low, the manual stamping device 1 has been placed on a print medium. The device operates offline during the implementation of the security-critical transactions, i.e. without establishing a data connection to a PC or a server.

If the manual stamping device 1 is placed on the base station, the sensor signal of the first sensor 34 does not change because the tactile transfer pin 341 is positioned over a recess 401 of the base station 40 and thus is not moved.

The base station has a convexity 402 which is positioned under the transfer pin 351 of the second sensor 35 and which moves the transfer pin 351 when the manual stamping device 1 is placed on the base station 40. If the sensor signal of the second sensor 35 changes from low to high, the manual stamping device 1 has been removed from the base station.

Alternatively, a contact of the socket 36 connected to the external interface with the contact point 46 can also be monitored. The latter is fashioned as a plug, wherein a contact pin is grounded or, respectively, is set to a ground potential. The second sensor 35 can then be omitted.

The external interface moreover has to fulfill the following primary functions:
power supply and, if necessary, recharging of an internal power source,
extension of the user interface,
data transfer from the security processor of the manual stamping device to the base station for its control for the purpose of servicing the inkjet print head,
downloading of data and application programs from the PC into the manual stamping device,
data transmission for data synchronization between manual stamping device and PC,
downloading of data from a remote data center via PC into the manual stamping device (for example, in the franking mode, the downloading of monetary data, downloading of mail products or mail tariff table data and the secure loading of vectors/keys for cryptographic operations that are executed in the security processor of the manual stamping device).

The universally usable electronic manual stamping device can be untethered from a location and be operated offline and, in the one mode, can work as a franker, wherein security-critical transactions are executed and individually secured stamp imprints are generated as a result. The relevant security requirements of the mail organizations that are different depending on the country are taken into account.

Moreover, the following modes can be selected as needed, for example:
use as an incoming mail stamper,
use as a sequential number printer,
use as a fee stamper,
use as a certificate printer.

If necessary, the required application program and data are to be downloaded from the PC into the manual stamping device or, respectively, be extended as necessary in individual software modules before the manual stamping device is separated from the base station.

At least the following operating modes can be differentiated in the franking mode:

I. Franking

II. Download money

Ill. Update the security data

IV. Download tariff table data or, respectively, mail product data.

Different, specific workflow diagrams of the manual stamping device than the following workflow diagram shown in FIG. 4 respectively apply for these operating modes II through IV.

A flowchart diagram 100 of the manual stamping device 1 in the franking operating mode is shown in FIG. 4. As soon as the manual stamping device 1 has been taken down from the base station, a first step 101 is reached and the workflow diagram 100 is started. A sub-program is initially started in the second step 102 in order to establish the selection of the mail product to be franked via a quick select button of the input means 7. The sub-program comprises at least one first and second query step (not shown). In a third query step 103 it is subsequently checked whether the remaining credit present in the manual stamping device is possibly too small in order to access the service of the mail carrier. In the event that the latter does not apply, the workflow branches to a fourth query step 104. However, in the event that the latter applies, an error display appears in the thirteenth step 113 for status signaling. The workflow then branches from the last step 113 back to the start of the second step 102.

In the fourth query step 104, after querying the sensor signal of the first sensor 34 it is checked whether the device is standing on the print medium. If the latter is the case, the workflow branches to a fifth query step 105. Otherwise a display “Place device” is output in the fourteenth step 114 for status signaling and the workflow then branches to a sixth query step 106. In the aforementioned sixth query step 106, after querying the sensor signal of the second sensor 35 it is checked whether the apparatus is standing on the base station. In the event that the latter does not apply, the workflow branches to a seventh step 107 in order to produce a cryptographic advance calculation for the security code of a subsequent stamp imprint. The workflow then branches from the last step 107 back to the start of the second step 102.

In the fifth query step 105 it is checked whether the start button has been actuated. In the event that the latter has not yet occurred, the workflow branches back to the start of the fifth query step 105. Otherwise the workflow branches to an eighth step 108 for booking the postage value with which the mail piece should be franked. In the subsequent ninth step 109 the calculation of the cryptographic security code is concluded. The workflow branches from the ninth step 109 to a tenth step 110 in which a print data preparation with the data matrix 2-D code is conducted. An eleventh step 111 is subsequently reached in which the stamp imprint including the cryptographic security code is printed. The sixth query step 106 is then reached. If the device is standing on the base station, the workflow branches from the sixth query step 106 to the end of the routine 100 in step 112.

The implementation of transactions in 1st operating mode “Franking” is explained in detail in the following statements. The following basic step sequence is executed until the end of the transaction:
a) provision of usable data as a result of the sub-program 102 to select the mail product to be franked via a quick select button,
b) transaction start as a result of the actuation of the start button, which is determined in the fifth query step 105,
c) an application-specific data processing for booking the postage value or, respectively, franking accounting in step 108,
d) usable data securing in step 109, here generation of a cryptographic checksum or of a security code,
e) data preparation in step 110,
f) stamp imprinting in step 111.

In the following the individual steps are described in detail using the exemplary embodiment in the 1st operating mode “Franking”.

a. Provision of Usable Data

In principle the following possible sources for the provision of usable data can be differentiated in the manual stamping device:
direct input of the usable data via keyboard or
selection of the usable data via quick select buttons.

The usable data here can be the postage value (for example 0.55 [symbol] ) for a standard letter or the product to be franked (for example standard letter in-country) that is programmed to a quick select button. In the latter case, the usable data are provided via the selection of a pre-programmed quick select button of the input unit. The operator selects the product to be franked via the quick select buttons. The software of the security processor that is connected with the input means detects a status change of the quick select buttons and stores the selection for further processing.

b. Transaction Start

In the manual stamping device the sources for the start of a transaction are to be queried:
sensor 34 and
switch 24.

In the aforementioned exemplary embodiment, the transaction is started by the operator via actuation of the start button (switch 24). For this the manual stamping device must already have been placed on the surface of the print medium (mail good). This placement is queried by, for example, a tactile transfer pin 341 of the microswitch (sensor 34) protruding through a hole in the base plate. The transaction is automatically prepared by means of microswitches via placement of the manual stamping device on the print medium.

The security processor of the controller is operationally connected with the input means and the start button 24 and the microswitch 34. The software of the security processor checks the status of the microswitch 34 and detects the actuation of the start button 24 by the user. If the start button 24 is now actuated, the software starts the transaction. Otherwise a status message is output.

The security processor of the controller is connected with the non-volatile memory. The software of the security processor executes the necessary operations of the transaction.

c. Application-Specific Data Processing

In the 1st operating mode “Franking”, the security processor of the manual stamping device stores different data sets and executes the following operations to store the quantity and the value in the mail registers:

| Application/Mode | Memory/Register Name | Operation |
|---|---|---|
| Franking/Franking | descending register | DR := DR − value |
| | ascending register | AR := AR + value |
| | piece counter | PC:= PC + 1 |

d. Securing Usable Data

The usable data should be cryptographically secured. For this a checksum of the usable data should be calculated. This should appear together with the usable data in a stamp imprint, possibly encrypted as a security code (cryptographic checksum). For this an individually secured stamp imprint is generated. The following principles can be applied to generate the cryptographic checksum:
Asymmetric digital signatures or
Symmetric Message Authentication Codes (MAC/T-MAC).

Among other things, a digital signature algorithm (DSA), an elliptical curve digital signature algorithm (ECDSA), an RSA method (named after the inventors Rivest, Shamir and Adlerman) or other methods can be used to generate asymmetric digital signatures.

Among other things, the following methods can be used to generate symmetric message authentication codes:
Data Encryption Standard (DES),
Advanced Encryption Standard (AES),
Hash-based Message Authentication Code (HMAC),
Secure Hash Algorithm 256 (SHA256).

Independent of the method used, an individual cryptographic key is required for the calculation of a cryptographic checksum. This key must be securely stored in the manual stamping device. The storage can occur in a non-volatile memory region within the security process or in encrypted form in a non-volatile memory connected with the security processor. In the exemplary embodiment, a cryptographic checksum is calculated from the following usable data stored in the device:
franking value (value),
license number (license ID),
date
remaining credit (DR),
used credit (AR),
quantity (PC) and others.

In the aforementioned exemplary embodiment of “Franking”, a truncated Message Authentication Code (T-MAC) is formed by means of the calculation rule AES. The cryptographic key (which is called the “indicia key” here) is used in the security processor of the device.

e. Print Data Preparation

The print data preparation converts the usable data and the cryptographic checksum into a graphical presentation of the data to be printed, which can subsequently be printed on the medium by means of an inkjet print head. For example, the following graphical presentations of the data to be printed are thereby possible:
plain text
OCR-readable text
1-D barcode
2-D barcode

Various fonts, for example OCR-A according to ISO 1073-1 or OCR-B according to ISO 1073-2, can be used for the generation of OCR-readable text.

Various barcode types, for example Code 128 according to ISO/IEC 15417 or Code 2/5 Interleaved according to ISO/IEC 16390, can be used for the generation of 1-D barcodes.

Various variants, for example PDF 417 according to ISO/IEC 15438 or DataMatrix according to ISO/IEC 16022, can be used for the generation of 2-D barcodes.

The selection of the respective presentation occurs depending on the application case or, respectively, country version and takes into account the data set to be presented and the requirements for legibility of the individually secured stamp imprint.

In the aforementioned exemplary embodiment of “Franking”, the data should be presented in a DataMatrix 2-D barcode. In addition to this, individual usable data (for example the franking value, the date or the license number, are printed as clear text.

f. Stamp Imprint

In the exemplary embodiment, the data are printed with a height of 12.8 mm. A deflection of the inkjet print head in the Y-direction is therefore not necessary.

In the “Franking” mode, the security processor executes the following security-critical tasks:
secure storage of the franking credit,
secure communication with the infrastructure,
secure storage of the “indicia” key and
secure calculation of the franking imprint.

During the “Franking” operating mode, the transaction module can conduct the secure storage of the franking credit and calculation of the franking imprint in order to generate franking imprints, for example according to the FrankIT standard of the Deutsche Post AG (DPAG).

Due to its mobility, simplicity and good usability as well as high security against manipulation and forgery, the franking solution with the universally usable electronic manual stamping device has advantages in the lower market segment with a throughput of approximately 5 imprints per day. To achieve low manufacturing costs, it is assumed that a production in larger quantities at correspondingly low prices is possible because the field of use of the device is very large.

In the following the individual steps are described in general for additional exemplary embodiments, wherein transactions are implemented by separate transaction modules for corresponding modes:
use as an incoming mail stamper,
use as a sequential number printer,
use as a sequential data printer or
use as a fee stamper or, respectively,
use as a certificate printer.
   aa. Provision of Usable Data

In principle, in the manual stamping device the following possible sources for the provision of usable data can be differentiated in general applications:
date and time of the manual stamping device as a source of usable data,
operation as an internally progressing counter as a source of usable data,
pre-programmed operation with data from a sequential file loaded into the manual stamping device in advance as a source of usable data and
operation with fee data that are loaded into the manual stamping device in advance and are retrieved via quick select buttons.
Operation with data (for example name) input into the manual stamping device.
   bb. Transaction Start

In principle, the following possible sources for the start of a transaction can be differentiated in the manual stamping device:
the transaction is initiated by the operator by pressing the start button (incoming mail stamp) and/or
the transaction is automatically initiated by means of microswitches by placing the manual stamping device onto the print medium.
   Such a trigger mechanism is reasonable given printing of sequential numbers in which they should be stamped “off the reel”, for example.
   cc. Application-Specific Data Processing

In the following, operations of the application-specific data processing are explained using examples of different application fields:

| Application/Mode | Memory Name | Operation |
|---|---|---|
| Incoming Mail Stamper | Calendar module | actual Date |
| | Internal clock | actual Time |
| | Sequence counter | SEQ:= SEQ +1 |
| Sequential number printer | Sequence counter | SEQ:= SEQ +1 |
| Fee stamp printer | Piece counter | PC:= PC +1 |
| | Fee register | GR := GR − value |
| Certificate printer | Name and | Name |
| | message class | Class |
| | Calendar module | actual Date |
| | Piece counter | PC:= PC +1 |

dd. Securing Usable Data

Given printing of a certificate, the usable data can be cryptographically secured. For this a checksum of the usable data should be calculated. This should appear together with the usable data in a certificate imprint, encrypted if necessary as a digital signature or security code (cryptographic checksum). For this an individually secured stamp imprint is again generated.

ee. Print Data Preparation

The print data preparation in the incoming mail stamper, sequential number printer and fee stamp printer modes converts the usable data into a graphical presentation (clear text, OCR-readable text, 1-D barcode or 2-D barcode) of the data to be printed that are subsequently printed on the print medium by means of an inkjet print head.

In the certificate printer mode, the possibility exists to print a digital signature or an equivalent security feature.

f. Stamp Imprint

Stamp imprints should be generated by means of an inkjet print head. The dimension of the stamp imprint determines the geometry of the printing unit. Typical inkjet print heads (for example the HP TIJ 2.5 cartridges) have a print line with a print height of ½ an inch, thus 12.8 mm.

The inkjet print head is activated by the security processor and supplied with print data. It is suspended such that it can move in the X-direction via an actuator. The print line sweeps over the print medium.

If a greater print height than 12.8 mm is required, for example, a deflection of the print head in the Y-direction is also necessary.

It is provided that a plurality of separate transaction modules for corresponding modes are components of the aforementioned integrated circuit.

During the implementation of the security-critical transactions the manual stamping device operates offline, thus without establishing a data connection to a PC or a server. The invention enables the use of the manual stamping device in mobile transport means, for example on the Inter-City Express (ICE). The inkjet print head can be protected from drying out by a cover (not shown) in intervening periods as long as no base station is available for its maintenance.

The control unit is programmed to control the printing and the base station on which the manual stamping device is fashioned to be placed for its maintenance and downloading of data.

Although modifications and changes may be suggested by those skilled in the art, it is the intention of the inventor to embody within the patent warranted hereon all changes and modifications as reasonably and properly come within the scope of his or her contribution to the art.

I claim as my invention:

1. A universally useable electronic manual stamping device comprising:
an inkjet print head;
a print head carriage on which said inkjet print head is mounted, said carriage being configurable for movement back and forth, with said inkjet print head, in a print window;
a base plate in which said print window is disposed facing toward a print medium during printing;
a control unit connected to a user interface, and an external interface, and comprising an internal interface;
said inkjet print head being operationally connected to said control unit via said internal interface;
an actuator mechanically connected to said print head carriage to move said print head carriage;
an internal power source connected to said control unit, said inkjet print head and said actuator to supply power to said control unit, said inkjet print head and said actuator;
a security processor comprising at least one transaction module configured to implement cryptographic security and certification procedures associated with printing a secured imprint by said inkjet print head on said print medium; and
said control unit being configured to control printing by said inkjet print head and being configured to control operation of a base station connectible to said manual stamping device for maintenance and data downloading.

2. A universally useable manual stamping device as claimed in claim 1 wherein said control unit comprises electronics formed by a single integrated circuit.

3. A universally useable electronic manual stamping device as claimed in claim 2 wherein said at least one transaction module is a component of said single integrated circuit.

4. A universally useable electronic manual stamping device as claimed in claim 3 comprising a housing in which said control unit with said single integrated circuit is contained, said housing comprising a housing region that is physically secured against tampering in which said integrated circuit is located.

5. A universally useable electronic manual stamping device as claimed in claim 2 comprising a plurality of separate transaction modules, respectively operable in different transaction modes, forming respective components of integrated circuit.

6. A universally useable electronic manual stamping device as claimed in claim 5 comprising a housing in which said control unit with said single integrated circuit is contained, said housing comprising a housing region that is physically secured against tampering in which said integrated circuit is located.
